(19) United States
(12) Patent Application Publication
(10) Pub. No.: US 2014/0265311 A1
(43) Pub. Date: Sep. 18, 2014

(54) INNER COUPLER FOR JOINING NON-METALLIC PIPE METHOD AND SYSTEM

(71) Applicant: Composite Fluid Transfer, LLC, Kilgore, TX (US)

(72) Inventor: Christopher Lynn Taylor, Tyler, TX (US)

(73) Assignee: Composite Fluid Transfer, LLC, Kilgore, TX (US)

(21) Appl. No.: 14/209,671

(22) Filed: Mar. 13, 2014

Related U.S. Application Data
(60) Provisional application No. 61/784,093, filed on Mar. 14, 2013.

(51) Int. Cl. F16L 13/02; F16L 13/10

(52) U.S. Cl. CPC F16L 13/0254; F16L 13/103
USPC 285/288.1; 156/272.2; 156/293; 156/187

(57) ABSTRACT

A process for joining thin walled non-metallic pipe using a tubular inner coupler. The inner coupler may be inserted into the pipe and bonded to the pipe. The inner coupler may include a shoulder to form an attachment point for clamping inner coupled pipe joints together. The pipe joint may be reinforced using a continuous fiber tape. The bonding may include electrofusion, adhesives, heating, and damping, of the inner coupler to the pipe.

### CROSS REFERENCE TO RELATED APPLICATION

This application claims the benefit of U.S. Provisional Patent Application No. 61/784,093 filed Mar. 14, 2013, which application is hereby incorporated by reference for all purposes in its entirety.

### BACKGROUND OF THE DISCLOSURE

1. Field of the Disclosure

This disclosure relates to a system and method for joining thin wall non-metallic pipes used in transporting liquids and gasses.

2. Description of the Related Art

Transporting fluids (or even gasses), such as water and chemicals can be costly and time consuming. For example, in today's energy scarce environment, efficient oil and was recovery techniques are vital. One means for inducing recovery is using an induced hydraulic fracturing method. “Fracturing fluids” or “pumping fluids” or “fracking fluids” consisting primarily of water and sand are injected under high pressure into the producing formation, creating fissures that allow resources to move freely from rock pores where it is trapped. Chemicals can be added to the water and sand mixture (creating a slickwater) to increase the fluid flow. Fractures provide a conductive path connecting a larger area of the formation to the well, thereby increasing the area from which natural gas and liquids can be recovered from the targeted formation.

Water for the fracturing method is supplied, to the recovery site and perhaps the fluid's byproduct from the fracturing method, known sometimes as flowback water, removed from the site) by a piping system. The piping system can consist of hundreds or thousands of yards of pipes. The piping system could include hundreds of pipes joined together by couplers to form the overall piping system. Although technically effective, environmentalists are concerned that tracking fluids may leak from the piping system thus causing, damage to the environment. Consequently, tatty areas where oil and gas reservoirs exist may not be exploited due to environmental concerns.

Traditional pipes used for transporting fluids, such as water, are made of steel or other metals, such as aluminum. More recent pipes are composed of a plastic material such as high density polyethylene (HDPE). HDPE pipes have some advantages over metal pipes, including lower costs, abrasion resistance, corrosion resistance, high impact resistance and greater flexibility (which are especially useful over uneven terrains). These pipes are durable for gas, chemical and water applications and may be reused.

For example, a typical Yelomine™ pipe has a weight density of 300 pounds (lbs.) per 30 feet (ft.) of length. This pipe has moderate durability but needs support structure (such as support blocks) during fluid transport use.

A typical aluminum pipe used in today's fluid transport system is light weight with a weight density of 90 lbs./30 ft of length. However it is not very durable and like the Yelomine™ pipe requires a support system during the fluid transfer. It has a pressure to weight ratio of a little more than 1.

Although HDPE pipes are in current use, such current use includes thick walled HDPE pipes, such as a DR9 HDPE pipe. To ensure the integrity of the piping system under high fluid transport pressure, the walls of the HOPE pipes are typically more than an inch thick. For example, the DR9 HDPE pipe has a wall thickness of 1.11 inches. The DR9 HDPE pipe has a weight density of a whopping 650 lbs./30 ft. It is highly durable but costs nearly 3 times more than an aluminum pipe. The pipes are difficult to transport in rough, uneven or forest terrains. Often, trucks or other mechanical movers are needed to transport the heavy pipes for construction of the system. These pipes are typically buried and then are not reusable. The pressure to weight ratio of the DR9 HDPE pipe is less than 0.4. Consequently, although thick walled HDPE pipes may be more durable than aluminum or Yelomine™ pipes, current thick walled HDPE pipes in industrial use remain very heavy. Furthermore, coupling these individual thick walled pipes to create the piping system may he slow and burdensome. That is, butt fusing systems are often used to join thick walled pipes. The use of the butt using system is often time consuming due to its process and the heavy equipment needed to be transported to the installation site for the connection of the pipes. In addition, as a result of environmental concerns, a coupler-less piping system or a system with few couplers is desirable since most leaks occur at a coupler or joint. Consequently, the use of current thick walled HDPE pipes may not be feasible in transporting liquids or gas over a great distance or through rough terrain under high pressure.

What is needed is a lightweight and cost effective HDPE piping system that can, among other things, withstand the environment and gas and fluid pressures of current oil and gas recovery methods. The novel system needs to be designed and constructed for easy transport and installation. The lightweight pipes can be lifted and carried by 2 men. The novel system needs to provide a high flow and a high strength solution. The system needs to allow for minimal blocks or a support system in an above ground application. Rather, the novel piping system can lie on the ground during use or span voids. However, below ground installation is not restricted by the novel system. Since the novel system can be made with a thermoplastic, such as HDPE, the piping system may be resistant to theft (since metal pipes are often stolen). In addition, the novel system may be used for other applications, such as water irrigation or temporary supply of water or removal of waste during emergencies or gas and chemical transport.

Typically, non-metallic pipes are joined using an exterior coupling that sleeves over the connection point. In order to install a sleeve on the ends of the pipes, the pipe cannot have any additional reinforcing layers to provide additional strength. Often the ends of the pipe may be strengthen by having pipe walls that are thicker at the ends than in the middle of the pipe. This requires additional pipe material and increases the weight of each pipe joint. What is needed is a method of joining pipe non-metallic pipe joints that does not require thickening a of the ends to accommodate sleeving and allows reinforcing layers to extend to the ends of the pipe joint.

### BRIEF SUMMARY OF THE DISCLOSURE

In aspects, the present disclosure is related to a system and method for joining thin wall non-metallic pipe for transportation of fluids. Specifically, the present disclosure is related to joining pipe joints using an inner coupler configured to provide an attachment point for a pipe clamp.

In accordance with the present disclosure, a mechanical piping system and a method for manufacturing piping elements for use in the mechanical piping system is disclosed. As disclosed herein, the system incorporating aspects of the present disclosure may include a pipe, wherein the pipe is a thinned wall and made of high density polyethylene (HDPE) material. During the construction process, the thin walled ROPE pipe is cooled and then wrapped with a thermoplastic fiber tape. The tape is made with continuous and taut fibers wherein the fibers can be made from glass, carbon or synthetic fiber such as Kevlar™ fibers). The tape is applied to the pipe at ambient room temperature (around 72 degrees F.) and relatively low humidity (for example, around 30 percent). The tape and pipe are heated by a heat source and then allowed to cool. When heated and later cooled, the tape bonds (creating a homogenous or monolithic bond) to the pipe creating a reinforced thin wall pipe. Ends of the pipe may be further wrapped by the tape to add reinforcement to the pipe's ends. The reinforced pipe may then be wrapped with a UV protective and abrasion resistant film. Should the pipe need to endure higher pressures, a second wrapping or more wrappings at ambient temperature of the thermoplastic fiber tape is applied, heated and cooled before the UV/abrasion resistant film is applied. The system may also include a coupling connector, wherein the interior of the connector engages with the exterior of the end of the pipe. Mechanical or electrical forces are used to secure the pipe's end to the coupling connector.

The system and method disclosed herein is technically advantageous because it creates a mechanical piping system for use in high pressure application, including high pressure water transport, water irrigation or temporary water supply and removal applications. The system and method are further advantageous because the piping elements for high pressure fluid and gas transport are lighter (allowing for 2 men delivery and construction) and more durable than in existing piping systems and are also less prone to leakage. The system and method are also advantageous in that they incorporate time saving elements, making deployment and or removal of the piping system easier and faster than in current applications. Other technical advantages will be apparent to those of ordinary skill in the art in view of the following specification, claims, and drawings.

Another embodiment of the present disclosure includes a method for manufacturing a non-metallic pipe system for transporting a fluid, the method comprising: bonding an inner coupler to a pipe joint, wherein the inner coupler and the pipe joint comprise a non-metallic material, and wherein the inner coupler comprises: 1) a first section that i) has an outer diameter that is substantially identical to an inner diameter of the pipe joint and ii) is configured for insertion into the pipe joint and 2) a second section with an outer diameter that is greater than an outer diameter of the pipe joint.

Another embodiment according to the present disclosure includes a non-metallic piping system, the system comprising: a pipe joint; and an inner coupler, the inner coupler comprising: a first section configured to be inserted in the pipe joint, and a second section wherein the inner coupler and the pipe joint comprise material.

Examples of the important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 is a perspective view of a tape weaved around a thermoplastic pipe according to the present disclosure;

FIG. 2 is a top view of a prior art thermoplastic fibered tape;

FIG. 3 is a sectional view of the thermoplastic pipe along line A-A of FIG. 1 according to the present disclosure;

FIG. 4 is a perspective view of a thermoplastic pipe wrapped with thermoplastic fibered tape according to the present disclosure;

FIG. 5 is a perspective view of a UV protective/Abrasion resistant tape applied to a thermoplastic fibered tape that is wrapped around a thermoplastic pipe according to the present disclosure;

FIG. 6 is a perspective view of a prior art coupler for joining thermoplastic pipes;

FIG. 7 is a perspective view of a prior art electronic fusion coupler;

FIG. 8 is a perspective view of a thermoplastic pipe with an exposed area according to the present disclosure;

FIG. 9 is a side view of an electronic fusion coupler joining thermoplastic pipes according to the present disclosure;

FIG. 10 is a flow chart of the method of manufacturing a reinforced thermoplastic pipe according to the present disclosure;

FIG. 11A is a diagram of an inner coupler and pipe joint according to the present disclosure;

FIG. 11B is a diagram of an inner coupler being inserted in pipe joint according to the present disclosure;

FIG. 11C is a diagram of an inner coupler partially inserted into a pipe joint according to the present disclosure;

FIG. 11D is a diagram of an inner coupler fully inserted into a pipe joint according to the present disclosure;

FIG. 11E is a diagram of an inner coupler fully inserted into a pipe joint with an electrofusion power source according to the present disclosure.

FIG. 12A is a diagram of an inner coupled pipe joint according to the present disclosure; and

FIG. 12B is a diagram of a shoulder bevel according to the present disclosure.

FIG. 13 is a diagram of an inner coupled pipe joint with reinforcing tape according to the present disclosure;

FIG. 14 is a diagram of two inner coupled pipe joints joined according to the present disclosure;

FIG. 15 is a flow chart of a method of forming and joining inner coupled pipe joints according to the present disclosure;

FIG. 16 is a flow chart, of another method of forming and joining inner coupled pipe joints according to the present disclosure;

FIG. 17 is a flow chart of another method of forming and joining inner coupled pipe joints according to the present disclosure; and

FIG. 18 is a flow chart of another method of forming and joining inner coupled pipe joints according to the present disclosure.

### DETAILED DESCRIPTION OF THE DISCLOSURE

Generally, the present disclosure relates to joining thin wall non-metallic pipe joints. Specifically, the joining of non-metallic pipe joints using an inner coupler bonded to the pipe joint. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated, and described herein.

In FIG. 1, a thin wall non-metallic pipe or tube 1 is shown. In one embodiment according to the present disclosure, the pipe 1 is a thin walled high density polyethylene pipe (HDPE). The use of HDPE as pipe 1 is exemplary and illustrative only, as other suitable non-metallic materials may be used as would be understood by a person of ordinary skill in the art with the benefit of the present disclosure. Unlike traditional prior an thick walled thermoplastic (e.g., polyethylene) pipes used for fluid/gas transport for oil and gas applications, the pipe 1 according to the present disclosure, has a thickness of less than 0.5 inches and, in some instances, less than 0.25 inches. Due to the pipe's thin wall, the pipe 1 is flexible. Furthermore, the thin walled pipe 1 would not be able to withstand the pressures and other factors in oil and gas applications, where in one embodiment fluid pressures exceed 200 PSI. For reinforcement, the pipe 1 is wound with a fiber tape 10. In one embodiment, the tape 10 is made of a similar material to the pipe, such as a high density polyethylene thermoplastic tape. The tape includes continuous fibers 15 that in one embodiment, as shown in FIG. 2, are taut and run along the length of the tape. Such tapes, such as fiberglass HDPE tapes, are manufactured by Ticona Engineering Polymers under the brand name Celstran™ (Model no. CFR-TP HDPE G0F70-01). In one embodiment, the tape is made of 70 percent fiberglass by weight and is a foot in width. Other widths such as 6 inches are contemplated. The fibers are continuously run (uni-directional) along the tape and are taut.

The pipe 1 is laid on a support platform and is cooled by a cooling apparatus (not shown). Such cooling, means could include a localized cooler or a cooling chamber. Other cooling methods are contemplated. In one embodiment, with an ambient room temperature of approximately 72 degrees F. and a dry humidity environment (in one embodiment, a relative humidity of around 30 percent), the pipe 1 is cooled until the outer surface temperature of the pipe is at 40 degrees F. or below. One skilled in the art would recognize that environmental conditions, such as temperature and humidity my affect the manufacturing process. The cooled pipe 1 is rotated along its central axis. As the pipe 1 is rotated, the tape 10 (generally at ambient room temperature) is applied to the pipe 1 to create a single layer of tape 10 over the pipe 1. To ensure complete coverage of the pipe 1 using a minimum amount of tape 10 (to reduce weight of the overall pipe), the tape 10 is applied securely in a barber pole fashion where some of the tape may overlap creating an overlap area 3. A heat source (such as an iron) (not shown) is used to secure the ends of the tape 10 to the outer surface of the pipe 1 to ensure that the tape 10 is tautly wound (without slack) around the pipe 1. The tape 10 and the pipe 1 are then heated by the same or another heat source 12 to a temperature to create a homogenous or monolithic bond. In one embodiment, the heat source 12 heats the tape 10 and the pipe 1 to a surface temperature of approximately 375 to 450 degrees F. The HDPE materials of both the tape and pipe melt creating a homogenous or monolithic bond. During the heating, process, the pipe 1 expands due to thermal expansion. Since the tape 10 is securely wrapped over the pipe 1 and the fibers 15 are continuous and taut, the fibers 15 of the tape 10 penetrate and embed itself to the pipe 1 as the pipe expands.

In FIG. 3, a cross sectional view of the thermoplastic pipe along, line A-A of FIG. 1 is shown. When cooled, the pipe 1 has a smaller diameter 31. Once warmed to an ambient temperature (e.g., near 72 degrees F.), the pipe's diameter 32 expands as a result of thermal expansion. The taut fibers 15 of the tape 10 become embedded into the pipe 1 as the pipe expands. Once the tape 10 and the pipe 1 cool to the ambient temperature creating a homogenous or monolithic bond, the fibers 15 are securely embedded in the pipe 1. The pipe 1 is reinforced by the fibers 15 and the lightweight thin wall pipe can now withstand the higher pressures and other factors.

As shown in FIG. 4, for further reinforcement, a second layer of fibered tape 18 may be applied to the pipe 25 in the opposite direction as the first layer of tape 10 (creating a crisscrossing pattern). Additional layers of the fibered tape may be added to the pipe 1 for additional reinforcement. Furthermore, in one embodiment, both ends of the pipe 25 are reinforced by application of an additional fiber tape 19. The tape 19 is snugly and securely wrapped perpendicular to the center axis of the pipe 25. In one embodiment, the tape 19 is tautly wrapped several times around the pipe 25 creating reinforced areas of the ends of the pipe 25 of approximately 4 to 8 ft. in length.

Next, a UV protective and abrasion resistant film may be applied to the pipe 1. One such film is manufactured by Valeron of Houston, Texas under the brand name V-Max™. As shown in FIG. 5, typically at ambient temperature (e.g., around 72 degree F.) and a dry environment (in one embodiment, the relative humidity is around 30), a UV protective/abrasion resistant film 48 is applied over the second layer fiber tape 18 and reinforced end tape 19 (not shown) in a similar barber poll pattern. However, similar to the directions of the first layer of tape 10 (shown in FIG. 3 for illustrative purposes, but generally would be covered by the second layer 18) and the second layer fiber tape 18, the UV/abrasion resistant film 48 would be applied on the pipe 40 against the direction of the second tape 18 (creating a crisscross pattern between the second layer 18 and UV/abrasion resistant tape 48). A heat source (not shown) is used to bond the film 48 to the fiber tape 18 of the pipe 40. In one embodiment, the film 48 has a width of 12 inches.

The novel pipe 40 is typically 30 feet in length. Thus, in one embodiment, a coupler is used to join various sections of the pipe 40 to create the piping system. An electrofusion coupler 30 is shown in FIG. 6. One exemplary coupler is manufactured by Integrity Fusion Products, Inc. of Georgia. The coupler 30 has inner diameter dimensions to allow the joining of various pipes 40. The coupler 30 has internal contact areas 35 where the outer surfaces of pipes meet up and bond with the inner surfaces of the coupler 30. Electrical ports 38 are provided to allow the entry of electrical wires to the contact areas 35.

FIG. 7 shows internal heating elements of the coupler 30. Heating elements 60 are wound within the internal surface of the coupler 30 creating the contact area 35. As an electrical current is applied to the elements 60, the resulting heat fuses the coupler 30 to the pipe 40.

Since the pipe 40 has been reinforced with the tapes 10 and 18 and UV protective/abrasion resistant film 48, the pipe, tapes and film may not effectively bond with the inner surface of the coupler 30.

FIG. 8 shows a perspective view of the reinforced pipe 70 according to the present disclosure. An end of the reinforced pipe 70 includes an exposed area 20 where the fiber tapes 10, 18 (not shown) and the UV protective/abrasion resistant film 48 have been removed. The exposed area 20 is the original thin walled HDPE pipe. In one embodiment, the exposed area is about 4⅞ inches in length. Removal of the tapes 10, 18 and the film 48 in the exposed area 20 can be done in many ways. In one embodiment, the tapes 10, 18 and the film 48 are scraped from the pipe 70 using a mechanical scrapper.

FIG. 9 shows a side view of two pipes joined by a coupler according to the present disclosure. The pipes 70 and 70″ are inserted into the coupler 30. Electrical ports 38 allow heating wires (not shown) to be wound to the internal surface of the coupler 30. The exposed areas 20 and 20″ of the outer surfaces of pipes 70 and 70″, respectively, are in contact with the heating surface of the coupler 30. As an electrical current is apply to the wires, the surfaces of pipes 70 and 70″ are bonded with the internal surfaces of the coupler 30 effectively joining the pipes 70 and 70″ together for fluid transport. Since the pipes 70 and 70″ include reinforced ends 72 and 72″, in one embodiment, the ends of the coupler 30 include beveled ends 80a along the lip of the coupler to allow the reinforced ends 72 and 72″ to fit snugly up against the coupler 30. In one embodiment, the angle for the bevels is approximately 22 degrees from the horizontal.

Other coupling means can be used with the pipes. In another embodiment, a re-usable two section EF coupler can be used to join the reinforced thermoplastic pipes. Thus, a thin wall thermoplastic pipe can be re-used without the need to cut the pipe from the couplers. The length of the pipes is not shortened thus allowing additional reuses of the pipes.

The pipe 70 is reusable. Typically, the initial length of the pipe 70 is 30 feet in length. To reuse the pipe 70 and depending on the type of coupler, the pipe is cut from the coupler 30. Ends of the cut pipe are scraped of the tapes 10, 18 and 48 to once again create an exposed area for further coupling of the pipe 70 at another site. The scraping of the tapes from the pipe's 70 outer surface ends can be done in the field, thus allowing for quick turnaround and reuse. Transport costs are reduced in view of the overall light weight of the thin wall thermoplastic pipe and light weight tape and film. In one embodiment, the novel piping system has a weight density of less than 128 lbs./30 feet. Application of the novel system can include transport of water during fracturing operations, removal of waste water from oil and gas sites or temporary supply of water or removal of waste water during emergency situations.

For example, in one embodiment, the novel piping, system can transport 150 bbls/minute with a 10.5″ inner diameter (ID)/11″ outer diameter thin walled HDPE pipe and 200 PSI with 1.5 SF. Furthermore, repair and reuse of the novel pipes are possible at a lower cost than traditional piping systems. The novel, system can be used above ground and without traditional support blocks or other support platforms in a piggy back configuration. The clearing of an area for the laying of the novel piping system may not be needed. The flexible piping system can be used in forests or other high density areas with obstacles. Since the pipes are made of HDPE materials, threat of theft is reduced (in comparison with metal pipes).

FIG. 10 is a flow chart identifying the steps of an exemplary method of manufacturing a reinforced thermoplastic pipe 1 according to the present disclosure. At step 1000, an HDPE pipe 1 is cooled. In one embodiment, the temperature of the outer surface of overall pipe 1 is around 40 degrees F. At step 1002, at ambient temperature, an HDPE continuous and taut fiber tape is wrapped around the outer surface of the cooled pipe. At step 1004, the tape and pipe are warmed to a surface temperature of 375 to 450 degrees F. At step 1006, as the tape and pipe are warmed, the fibers in the tape are embedded into the pipe due to thermal expansion of the pipe and the taut characteristic of the wrapped fibers. At step 1008, as the tape and pipe cool, a homogenous bond occurs. At step 1010, a second HDPE continuous and taut fiber tape is wrapped around the first tape in an opposite direction. At step 1012, heat is applied to the second tape and when cooled, the second tape homogenously bonds to the first tape. In one embodiment the surface of the second tape is heated to around 375 to 450 degrees F. At step 1014, a UV protective/abrasion resistant film is wrapped around the second tape in an opposition direction from the second tape. At step 1016, the film is heated and when cooled the film bonds to the second tape.

FIG. 11A shows a pipe joint 1100 with an inner coupler 1110 according to one embodiment of the present disclosure. The pipe joint 1100 may be composed of a thin wall non-metallic material. The non-metallic material may include one or more of: HDPE, suitable plastics, and ceramics. The inner coupler 1110 may he tubular and composed of the same material as the pipe joint 1100. The inner coupler 1110 may have a first section 1120 and a second section 1130.

The first section 1120 may be configured to fit inside of the pipe joint 1100. The first section 1120 may have an outer diameter 1122 that substantially the same as an inner diameter 1101 of the pipe joint 1100. The difference between the outer diameter 1122 and the inner diameter 1101 may be sufficient for the application of a bonding agent between the first section 1120 and the pipe joint 1100.

The bonding agent may include any suitable material or structure for bonding the first section 1120 to the pipe joint 1100. The bonding agent may include, but is not limited to, an adhesive and an electrofusion coil 1140. In some embodiments, the pipe joint 1100 may be circumferentially compressed by a clamp (such as a hose clamp to bond with the first section 1120. In another embodiment, the bonding of the first section 1120 to the pipe joint 1100 may not require a bonding agent.

The second section 1130 may have an outer diameter 1132 that is greater than an outer diameter 1102. The shoulder 1150 is the portion of second section 1130 that extends beyond the outer diameter 1102 and is configured to receive a clamp 1400 (FIG. 14) that will secure the second section 1130 inserted in pipe joint 1100 to another second section 1130 inserted in another pipe joint 1100.

FIG. 11B shows the movement of the pipe joint 1100 and the inner coupler 1100 toward one another. FIG. 11C shows the partial insertion of the inner coupler 1100 into the pipe joint 1100. FIG. 11D shows the inner coupler 1110 after full insertion into pipe joint 1100. FIG. 11E shows an electrofusion power source 1160 connected to the electrofusion coil 1140 of inner coupler 1140. When power is applied, the surface of inner coupler 1110 may be heated until molten such that a bond will form between the interior surface of pipe joint 1100 and the exterior surface of inner coupler 1110. Upon cooling, the suitable non-metallic material will create a seamless bond between pipe joint 1100 and inner coupler 1110 forming an inner coupled pipe joint 1170. In some embodiments, the bonding involve inserting the inner coupler 1110 into the pipe joint 1100 while the bonding surface of at least one of the inner coupler 1110 and the pipe joint 1100 is molten from preheating. The inner coupled pipe joint 1170 retains shoulder 1150, which may provide an attachment point between adjacent inner coupled pipe joints 1170. In some embodiments, an inner coupled pipe joint 1170 may be joined to another apparatus (tubular or otherwise) with a compatible fitting that is not another inner coupled pipe joint 1170.

FIGS. 12A and 12B show a close ups of an exemplary inner coupled pipe joint 1170 suitable for use in embodiments of the present disclosure. The shoulder 1150 may have a beveled portion 1200. The beveled portion may be beveled at an angle 1210. The beveled portion 1200 may be used to improve the clamp 1400 attachment between shoulders 1150 when inner coupled pipe joints 1170 are joined. In some embodiments, the beveled angle 1210 may be about 10 degrees to about 30 degrees.

FIG. 13 shows exemplary inner coupled pipe joint 1170 that has been wrapped in a first layer of tape 1300. Conventional joining techniques often involve sleeving at the connection point. Sleeving requires that the tape 1300 not extend all the way to the end of the pipe joint, but leave a space sufficient for a sleeve to be installed. The sleeve space is a gap in reinforcement where the pipe joint is weaker due to the absence of tape 1300 unless the pipe joint is thickened to compensate. Here, the first layer of tape 1300 may be configured to add hoop strength to the pipe joint 1170 that extends over pan or all of the pipe 1100 (up to shoulder 1150, which is left open for a joining connector, such as a clamp). The tape layer 1300 may extend along, the entire length of the pipe joint 1100 due to the location of the inner coupler 1110 on the inside of pipe joint 1100. The first layer of tape 1300 may be applied to pipe joint 1100 prior to the bonding of inner coupler 1110, such that the added hoop strength is present during the bonding process. The fiber tape 1300 may be identical in composition and structure to the fiber tape 19.

FIG. 14 shows an exemplary joining of the inner coupled pipe joint 1170 with another inner coupled pipe joint 1170′. The clamp 1400 may be disposed to contact the beveled sections 1200, 1200′.

FIG. 15 shows a flow chart of an exemplary joining method 1500 according to one embodiment of the present disclosure. En step 1510, pipe joint 1100 may be wrapped with tape 1300. In step 1520, the inner coupler 1110 with electrofusion coil 1140 may be inserted into pipe joint 1100. In step 1530, the exterior surface of inner coupler 1110 may be heated until molten by an electric current in electrofusion coil 1140 and supplied by power source 1160. In step 1540, the exterior surface of inner coupler 1110 may bond with the interior surface of pipe joint 1100 as the molten material cools, forming inner coupled pipe joint 1170. The cooling may be active or passive. In step 1550, the inner coupled pipe joint 1170 may be joined to another inner coupled pipe joint 1170 with a clamp 1400. The inner coupled pipe joint 1170 may include a beveled section 1200 configured to receive the clamp 1400. In some embodiments, step 1510 is optional. In some embodiments, step 1510 may take place after step 1540 and/or after step 1550. In some embodiments, step 1510 may be repeated at least one additional time to add a second layer of tape as shown in FIG. 10.

FIG. 16 shows a flow chart of an exemplary joining, method 1600 according to another embodiment of the present disclosure. In step 1610, the exterior surface of inner coupler 1110 and/or the interior surface of pipe joint 1100 may be heated until molten. In step 1620, the inner coupler 1110 may be inserted into pipe joint 1100 while at least one of the surfaces remains molten. In step 1630, the exterior surface of inner coupler 1110 may bond with the interior surface of pipe joint 1100 as the molten material cools, forming inner coupled pipe joint 1170. The cooling may be active or passive. In step 1640, pipe joint 1100 may be wrapped with tape 1300. In step 1650, the inner coupled pipe joint 1170 may be joined to another inner coupled pipe joint 1170 with a clamp 1400. In some embodiments, step 1640 is optional. In some embodiments, step 1640 may take place before step 1610 and/or after step 1650, In some embodiments, step 1640 may be repeated at least one additional time to add a second layer of tape as shown in FIG. 10.

FIG. 17 shows a flow chart of an exemplary joining method 1700 according, to another embodiment of the present disclosure. In step 1710, an adhesive may be applied to the exterior surface of inner coupler 1110 and/or the interior surface of pipe joint 1100. In step 1720, the inner coupler 1110 may be inserted into pipe joint 1100. In step 1730, the exterior surface of inner coupler 1110 may bond with the interior surface of pipe joint 1100 as the adhesive sets, forming inner coupled pipe joint 1170. In step 1740, pipe joint 1100 may be wrapped with tape 1300. In step 1750, the inner coupled pipe joint 1170 may be joined to another inner coupled pipe joint 1170 with a clamp 1400. In some embodiments, step 1740 is optional. In some embodiments, step 1740 may take place before, after, or during any of steps 1710, 1720, 1730, and 1750. In some embodiments, step 1740 may be repeated at least one additional time to add a second layer of tape as shown in FIG. 10.

FIG. 18 shows a flow chart of an exemplary joining method 1800 according to one embodiment of the present disclosure. In step 1810, pipe joint 1100 may be wrapped with tape 1300. In step 1820, the inner coupler 1110 may be inserted into pipe joint 1100. In step 1840, the exterior surface of pipe joint 1100 may be circumferentially compressed by a compression clamp (not shown) until the exterior surface of inner coupler 1110 is in contact with the interior surface of pipe joint 1100, forming inner coupled pipe joint 1170. In step 1850, the inner coupled pipe joint 1170 may be joined to another inner coupled pipe joint 1170 with a clamp 1400. In some embodiments, step 1810 is optional. In some embodiments, step 1840 is optional. In some embodiments, step 1840 may take place before, after, or during any of steps 1810, 1820, and 1850. In some embodiments, step 1840 may be repeated at least one additional time to add a second layer of tape as shown in FIG. 10.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method for manufacturing a non-metallic pipe system for transporting a fluid, the method comprising:
bonding an inner coupler to a pipe joint, wherein the inner coupler and the pipe joint comprise a non-metallic material, and wherein the inner coupler comprises: 1) a first section that i) has an outer diameter that is substantially identical to an inner diameter of the pipe joint and ii) is configured for insertion into the pipe joint and 2) a second section with an outer diameter that is greater than an outer diameter of the pipe joint.

2. The method of claim 1, further comprising:
inserting the inner coupler into the pipe joint.

3. The method of claim 2, wherein the bonding comprises electrofusion welding.

4. The method of claim 2, wherein the bonding comprises applying an adhesive.

5. The method of claim 2, wherein the bondimg comprises circumferentially compressing the pipe joint around the inner coupler

6. The method of claim 2, wherein the bonding comprises heating until molten at least one of:
heating at least part of an exterior surface of the inner coupler, and
heating at least part of an interior surface of the pipe joint.

7. The method of claim 1, wherein the non-metallic material comprises High Density Polyethylene (HDPE).

8. The method of claim 1, further comprising:
clamping the second portion of the inner coupler to a second portion of an additional inner coupler configured for insertion into an additional pipe joint.

9. The method of claim 1, further comprising:
wrapping a first fiber tape on an exterior surface of the pipe joint, the first fiber tape having continuous taut fibers;
securing the ends of the first fiber tape with the ends of the pipe joint using heat;
warming the first fiber tape and the pipe joint with heat;
embedding the continuous taut fibers into the pipe joint as the pipe joint is heated; and
bonding the first fiber tape to the pipe joint as the first fiber tape and the pipe joint reach thermal equilibrium.

10. The method of claim 9 wherein continuous taut fibers comprise unidirectional fibers of at least one of: i) fiberglass, carbon, and iii) synthetic fibers.

11. The method of claim 9 wherein the first fiber tape is a polyethylene tape.

12. The method of claim 9, further comprising:
wrapping a second fiber tape over a surface of the first fiber tape, where the second fiber tape has a composition identical to the first fiber tape.

13. The method of claim 12, wherein the second fiber tape is wrapped in a direction that is not identical to the direction of the wrapped first fiber tape.

14. The method of claim 12, further comprising:
applying a film over a surface of the second fiber tape.

15. The method of claim 13, wherein the film is at least one of abrasion resistance and UV resistant.

16. The method of claim 1, wherein the pipe joint is thin walled,

17. The method of claim 1, wherein the pipe joint has a wall thickness of less than 0.25 inches.

18. The method of claim 1, wherein the second section of the inner coupler comprises a first edge and a second edge, the first side being disposed adjacent to the first section, and wherein a portion of the first edge outside the exterior diameter of the pipe joint is beveled at an angle of about 10 degrees and about 30 degrees.

19. A non-metallic piping system, the system comprising:
a pipe joint; and
an inner coupler, the inner coupler comprising:
a first section configured to be inserted in the pipe joint, and
a second section;
wherein the inner coupler and the pipe joint comprise a non-metallic material.

20. The system of claim 19, wherein the first section is tubular and has an outer diameter that is substantially identical to an inner diameter of the pipe joint, and wherein the second section is tubular and has an outer diameter that is greater than an outer diameter of the pipe joint.

21. The system of claim 19, further comprising:
an electric coil wrapped around an outer diameter of the first section.

22. The system of claim 21, further comprising:
an electric power source configured send an electric current though the electric coil.

23. The system of claim 19, further comprising:
an adhesive configured to bond the first section to an interior surface of the pipe joint.

24. The system of claim 19, further comprising:
a clamp configured to provide uniform circumferential compression of a part of the pipe joint around the inner coupler.

25. The system of claim 19, further comprising:
a heat source configured to heat at least one of:
at least part of an exterior surface of the inner coupler, and
at least part of an interior surface of the pipe joint.

26. The system of claim 19, wherein the non-metallic material comprises High Density Polyethylene (HDPE).

27. The system of claim 19, further comprising:
a second pipe joint;
a second inner coupler identical to the first inner coupler; and
a clamp configured to claim the second section of the first inner coupler to a second section of the second inner coupler.

28. The system of claim 19, further comprising
a first fiber tape having continuous taut fibers configured to he wrapped around the first pipe joint;
a heat source configured to apply sufficient heat to bond to the first fiber tape and the first pipe joint

29. The system of claim 28, wherein the continuous taut fibers comprise unidirectional fibers of at least one of: i) fiberglass, carbon, and iii) synthetic fibers.

30. The system of claim 28 wherein the first fiber tape is a polyethylene tape.

31. The system of claim 28, further comprising:
a second fiber tape configured to be wrapped over a surface of the first fiber tape, where the second fiber tape has a composition identical to the first fiber tape.

32. The system of claim 31, wherein the first fiber tape is disposed on the surface of the pipe joint in a first direction and the second fiber tape is disposed on the surface of the first fiber tape in a second, non-identical direction.

33. The system of claim 31, further comprising:
a film configured to be applied to a surface of the second fiber tape.

34. The system of claim 33, wherein the film is at least one of: abrasion resistance and UV resistant.

35. The system of claim 19, wherein the pipe joint is thin walled.

36. The system of claim 19, wherein the pipe joint has a thickness of less than 0.25 inches.

37. The system of claim 19, wherein the second section of the inner coupler comprises a first edge and a second edge, the first side being disposed adjacent to the first section, and wherein a portion of the first edge outside the exterior diameter of the pipe joint is beveled at an angle of about 10 degrees and about 30 degrees.
